(19) United States
(12) Patent Application Publication
(10) Pub. No.: US 2015/0193084 A1
(43) Pub. Date: Jul. 9, 2015

(54) DISPLAY INPUT DEVICE

(71) Applicant: NITTO DENKO CORPORATION, Ibaraki-shi, Osaka (JP)

(72) Inventor: Noriyuki Juni, Ibaraki-shi (JP)

(73) Assignee: NITTO DENKO CORPORATION, Ibaraki-shi, Osaka (JP)

(21) Appl. No.: 14/411,950

(22) PCT Filed: Jul. 8, 2013
(86) PCT No.: PCT/JP2013/068580

§ 371 Date: Dec. 30, 2014

(30) Foreign Application Priority Data
Jul. 19, 2012 (JP) 2012-160314

(51) Int. Cl. G06F 3/042; G09G 5/00; G09G 3/00; G09G 3/34; G03B 21/00; G09F 19/16

(52) U.S. Cl. CPC G06F 3/0421; G03B 21/00; G09F 19/16; G09G 3/003; G09G 3/346; G09G 5/00

(57) ABSTRACT

In a display input device, a panel-shaped image-forming optical element in an upper portion of a case having an open upper surface is disposed at a predetermined position in the opening of the upper surface of the case, and a mounting stand for a flat panel display in a lower portion of the case corresponding to the image-forming optical element is disposed in an attitude inclined at a predetermined angle with respect to the image-forming optical element. An image displayed on the flat panel display is image-formed as a spatial image at a position spaced apart from the image-forming optical element. A touch input device which converts an operator's instruction input into an instruction signal to transmit to a control means for the flat panel display and which allows the manipulation of the spatial image projected in space is disposed outside the case.

### TECHNICAL FIELD

The present invention relates to a display input device which displays a two-dimensional image such as a photograph as a spatial image floating up in space, and which allows an operator to interactively manipulate this spatial image by touching with his or her hand or finger.

### BACKGROUND ART

Known schemes for displaying (projecting) images, video pictures and the like in space include a two-eye scheme, a multi-eye scheme, a spatial image scheme, a volume display scheme, a hologram scheme and the like. In recent years, there has been proposed a display input device which allows an operator to intuitively perform interactive manipulation (interaction) on a two-dimensional video picture or a three-dimensional video picture (a spatial image) displayed in the aforementioned space with a hand, a finger and the like (referred to hereinafter as a finger).

As a recognition input means (user interface) for a finger in such a display input device, there has been proposed a system which forms a lattice of vertical and horizontal light beams in a sensing region (plane) by using a multiplicity of LEDs, lamps and the like to sense the interception of the lattice of light beams by an input body (finger and the like) by means of a light receiving element and the like, thereby detecting the position or coordinates of the input body (with reference to Patent Literatures 1 and 2).

### RELATED ART DOCUMENT

### Patent Document

[Patent Document 1] Japanese Published Patent Application No. 2005-141102

[Patent Document 2] Japanese Published Patent Application No. 2007-156370

### SUMMARY OF THE INVENTION

Unfortunately, the aforementioned display input device is not always placed near the operator. The operator must reach out his or her finger and the like used for manipulation into proximity to the display input device to manipulate the display input device. Also, there is apprehension that the recognition input means using the aforementioned lattice of light beams cannot be installed or becomes unstable because of the decrease in input accuracy, depending on the ambient environments for manipulation.

In view of the foregoing, it is therefore an object of the present invention to provide a display input device which allows the manipulation of a spatial image projected in space in any type of environment with reliability.

To accomplish the aforementioned object, a display input device according to the present invention is a display input device for image-forming a video picture displayed on a display surface of a flat panel display by means of an optical element having an image-forming function in a manner floating up at a spatial position spaced apart from the image-forming optical element and for interactively updating the video picture on said flat panel display in response to an operator's instruction input. The display input device comprises: a mounting stand for placing a flat panel display thereon; a control means for the flat panel display; a panel-shaped image-forming optical element; a case for housing these components; and a touch input device disposed outside the case, said image-forming optical element being disposed at a predetermined position in an opening of an upper surface of said case, said mounting stand being disposed at a lower position of the case corresponding to the image-forming optical element in an attitude inclined at a predetermined angle with respect to said image-forming optical element, said touch input device being configured to convert an operator's instruction input into an instruction signal to transmit the instruction signal to said control means, said control means causing said flat panel display to display a video picture corresponding to the instruction signal, based on the instruction signal.

In the display input device according to the present invention, the aforementioned image-forming optical element is disposed at the predetermined position in the opening of the upper surface of the aforementioned case. The aforementioned mounting stand is disposed at a lower position of the case corresponding to the image-forming optical element in an attitude inclined at the predetermined angle with respect to the aforementioned image-forming optical element. The aforementioned flat panel display is placed in an attitude inclined at the predetermined angle on the mounting stand. With this configuration, a two-dimensional image such as a photograph is projected (image-formed) in a manner floating up (standing up) over the case which houses the flat panel display.

In the display input device according to the present invention, the touch input device which converts an instruction input with an operator's finger and the like into an instruction signal to transmit the instruction signal to the control means is disposed outside the case which projects the aforementioned image in space. Upon receipt of the aforementioned instruction signal, the control means for the flat panel display causes the aforementioned flat panel display to display a video picture corresponding to the instruction signal (operator's instruction), based on the instruction signal. Thus, the display input device according to the present invention allows an operator to touch the aforementioned touch input device with a finger and the like, thereby carrying out the input which is not influenced by environments and conditions with reliability. Additionally, the aforementioned display input device may serve as a user-friendly device which allows the interactive manipulation of a mirror image floating up in the aforementioned space.

In the display input device according to the present invention, when the aforementioned touch input device is a touch panel device allowing the input of coordinates in two directions orthogonal to each other, an operator can intuitively manipulate the video picture floating up in the aforementioned space in two directions associated with the motion of the operator's finger and the like. Thus, the display input device according to the present invention allows the operator to feel that the two-dimensional image appearing three-dimensional is more realistic.

### BRIEF DESCRIPTION OF THE DRAWINGS

FIG. 1 is a sectional view showing the configuration of a display input device according to a first embodiment of the present invention.

FIG. 2 is a view illustrating a method of using the display input device according to the first embodiment of the present invention.

FIG. 3 is a partial sectional view illustrating a method of setting a flat panel display in the display input device of the aforementioned first embodiment.

FIG. 4A is a schematic enlarged view of a micromirror array for use in the aforementioned embodiment of the present invention, and FIG. 4B is a view illustrating a manner of image formation of a spatial image by means of the micromirror array.

FIG. 5 is a view illustrating a method of using the display input device according to a second embodiment of the present invention.

FIG. 6 is a partial sectional view illustrating a method of setting a flat panel display in the display input device of the aforementioned second embodiment.

### DESCRIPTION OF EMBODIMENTS

Next, embodiments according to the present invention will now be described in detail with reference to the drawings. It should be noted that the present invention is not limited to the embodiments.

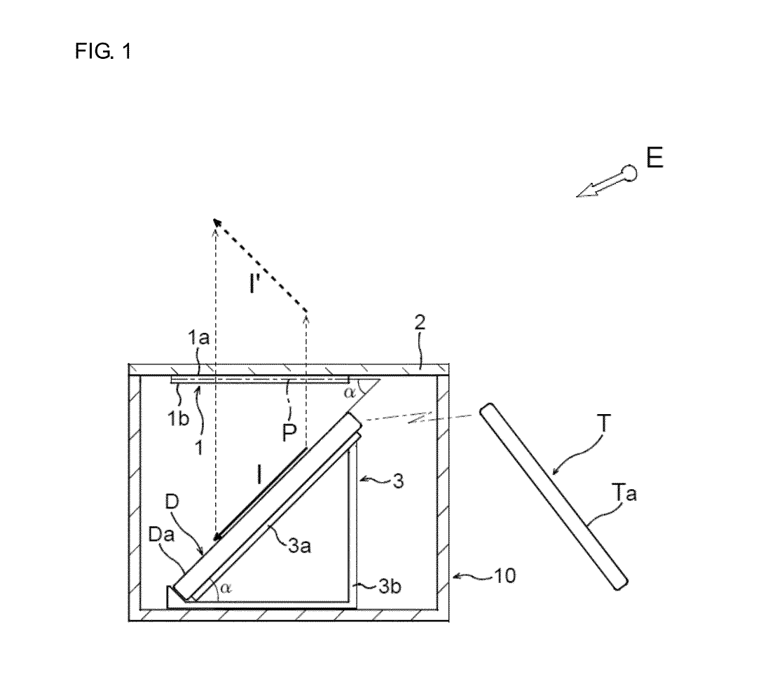

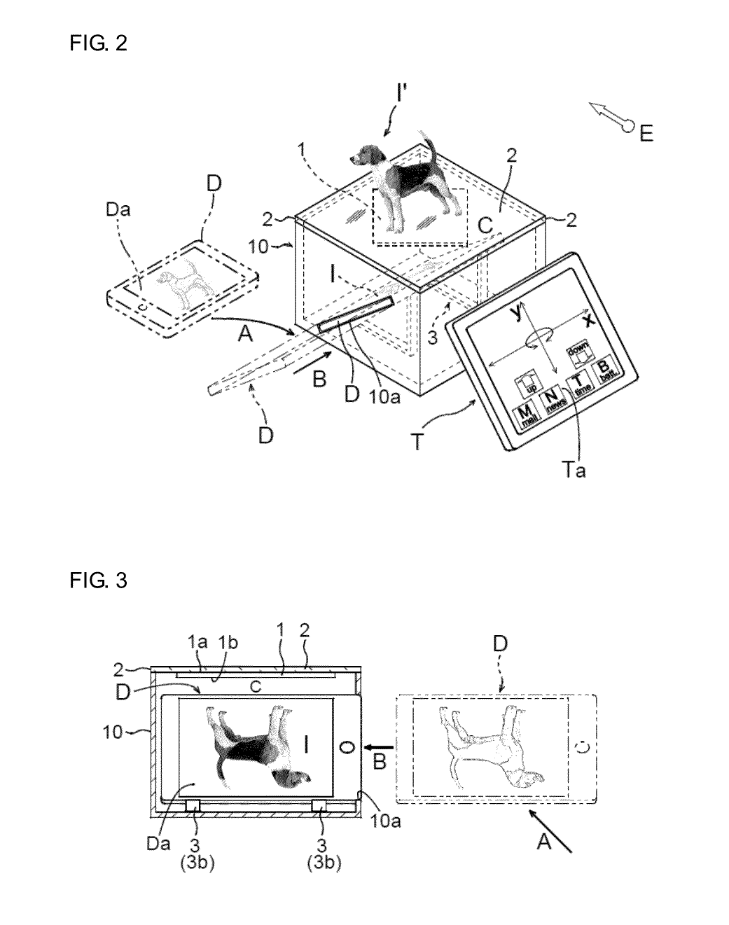

FIG. 1 is a schematic sectional view showing the configuration of a display input device according to a first embodiment of the present invention. FIG. 2 is a view illustrating a method of using the aforementioned display input device. A screen of a liquid crystal display device (LCD) for a cellular mobile phone (smartphone and the like) is used for a flat panel display (reference character D) in the present example. The reference character E in the figure designates the position of an eyepoint of an operator, and a hollow arrow thereof indicates the direction of an operator's line of sight. The reference numeral 2 in the figure designates a transparent plate-like member (transparent plate) which covers an opening of the upper surface of a case 10. In the figure, the thicknesses of an “image” (thick arrow I and the like in FIG. 1) displayed on the screen of the LCD and a projected “spatial image” (dotted arrow I′ and the like in FIG. 1) are shown in exaggeration.

In the display input device according to the present embodiment, a mounting stand 3 for placing the flat panel display D thereon and a panel-shaped image-forming optical element 1 are disposed in the box-like case 10 having a bottom and an open upper surface, as shown in FIG. 1. A smartphone (D) on the aforementioned mounting stand 3 includes a control means for controlling the display on the aforementioned flat panel display D, and is placed at a position opposed to and directly under (immediately under) the lower surface 1b of the aforementioned image-forming optical element 1 in an attitude inclined at an angle α with respect to this image-forming optical element 1. A touch input device (touch panel T) for manipulated input is located near (outside) this case 10. This touch panel T converts an operator's instruction input into an instruction signal to transmit the instruction signal to the aforementioned control means, so that the aforementioned flat panel display D displays a video picture (image) corresponding to this instruction signal. This is a characteristic of the display input device according to the first embodiment of the present invention.

The display input device according to the aforementioned first embodiment will be described in detail. The transparent plate 2 disposed in the opening of the upper surface of the aforementioned case 10 and covering this case 10 is provided for the transmission of light (image formation of the spatial image I′) in the direction of the case opening (vertical direction) and for attachment (positioning and fixing) of the aforementioned image-forming optical element 1 and the like. The transparent plate 2 is formed from a hard plate-like member having a visible light range transmittance of not less than 80%, such as a glass plate and an acrylic resin plate.

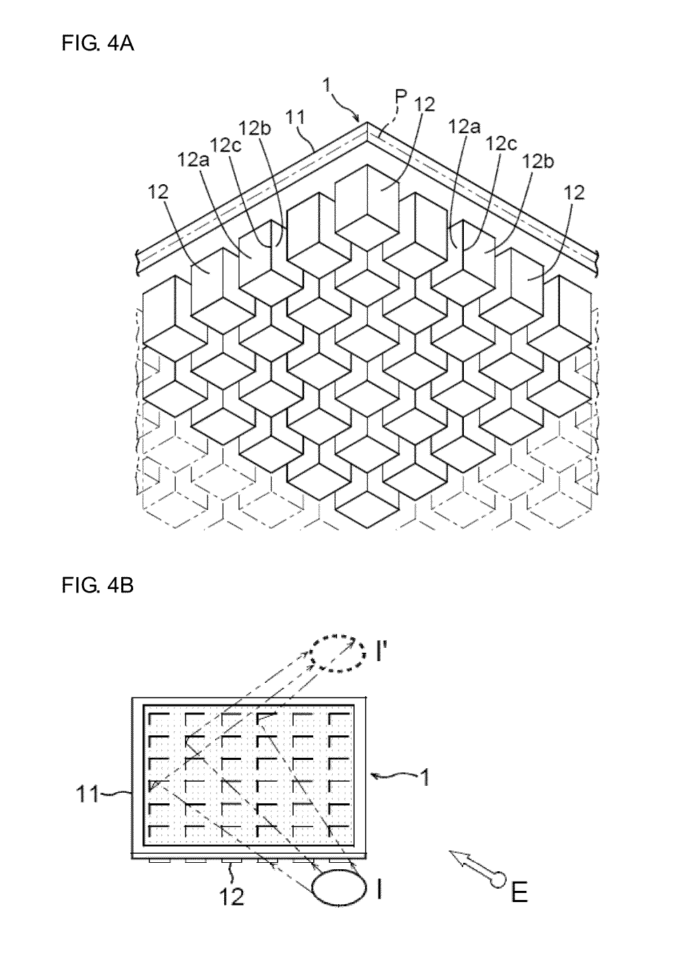

The panel-shaped image-forming optical element 1 attached to the aforementioned transparent plate has an image-forming function for image-forming an image I, a video picture and the like present on one side of the image-forming optical element 1 as a real image (spatial image I′) on the other side thereof. Examples of the image-forming optical element 1 for use in the display input device according to the present invention include: refraction type image-forming elements such as various lenses including Fresnel lenses and the like, micromirrors of afocal optical systems, and corner reflectors; and erect unity-magnification type image-forming elements such as microlens arrays. Of these, a micromirror array (protruding corner reflector array, with reference to FIG. 4 for detailed structure) which forms an image at a position symmetrical thereto with respect to the plane of an element surface P of the image-forming optical element 1, as shown in FIG. 1, is preferably used in the present invention. In this example, the aforementioned micromirror array (image-forming optical element 1) is shown as attached to the lower surface (inner surface) side of the transparent plate 2 (lid member) attached to the opening of the upper surface of the aforementioned case 10. Instead, an opening (hole) identical in shape with the image-forming optical element 1 may be provided in the aforementioned transparent plate 2, so that this image-forming optical element 1 is fitted and fixed in this opening.

The aforementioned micromirror array (corner reflector array) will be described in further detail. As shown in the bottom view of FIG. 4A, this micromirror array includes a multiplicity of downwardly protruding minute unit optical elements 12 (corner reflectors) which are provided on the lower surface (the lower surface 1b side of the image-forming optical element 1 in FIG. 1) of a substrate (base) 11 and arranged in a diagonal checkerboard pattern. In each of the unit optical elements 12, two light reflecting surfaces (a first side surface 12a and a second side surface 12b) which form a corner 12c are designed to face toward the eyepoint of the operator (E side in FIGS. 1 and 2). When this micromirror array (image-forming optical element 1) is viewed from above, the aforementioned array is disposed, with the outer edges (outer sides) thereof rotated 45 degrees with respect to the front of the aforementioned case 10 (the direction E on the operator side) (i.e. a corner of the outer edges facing the operator side), as shown in the top view of FIG. 4B. The image I under the image-forming optical element 1 is image-formed as the spatial image I′ at a position (over the image-forming optical element 1) symmetrical thereto with respect to the plane of the image-forming optical element 1.

Next, as shown in FIGS. 1 and 2, the mounting stand 3 for placing the aforementioned flat panel display D thereon includes a plate-like member 3a, and a pair of left-hand and right-hand bases 3b supporting this plate-like member 3a in an obliquely standing attitude, and is disposed at a position opposed to the lower surface 1b of the aforementioned image-forming optical element 1 (vertically below the image-forming optical element 1) inside the case 10. The aforementioned plate-like member 3a in an attitude inclined at a predetermined angle α with respect to the bottom surface of the case 10 and the element surface P of the image-forming optical element 1 (or the lower surface 1b of the image-forming optical element 1) is supported and fixed by the aforementioned bases 3b. The plate-like member 3a has an upper surface serving as a mounting surface for placing the flat panel display D thereon. By placing a smartphone and the like including the flat panel display D on the mounting surface (on the plate-like member 3a) of the aforementioned mounting stand 3, a display surface Da of the aforementioned flat panel display D is held in an attitude inclined at the angle α with respect to the element surface P of the image-forming optical element 1. It should be noted that the inclination angle α of the aforementioned mounting stand 3 inside the case 10 with respect to the element surface P (lower surface 1b) of the image-forming optical element 1 is adjusted so that the image-forming optical element 1 produces the optimum image-forming function, and is generally not less than 30 degrees and less than 90 degrees, and preferably in the range of 40 to 80 degrees.

It is desirable that examples of the flat panel display D for use in displaying the aforementioned image I include display panels capable of reproducing “white” as balanced as possible over all visible wavelengths and “black” when in a non-display state with good contrast, such as plasma display panels and organic EL display panels, in addition to liquid crystal display panels (LCDs) with backlights. The flat panel display D may be a display part for a cellular mobile phone, a personal digital assistant or the like as in this example. Specifically, normally exposed (uncovered) type display parts of smartphones, tablet PCs, digital photo frames, portable game machines, portable book readers, PDAs, electronic dictionaries and the like which are sized to be placeable on the aforementioned mounting stand 3 may be used as the flat panel display D. When a display with no backlight is used, light may be emitted from a separately provided light source toward a display screen thereof, so that the reflected light is used.

The aforementioned smartphone includes programs (engine) or applications for controlling the display on the aforementioned flat panel display D. Based on a signal (instruction signal) inputted from the touch panel T to be described later, a controller for the aforementioned flat panel display D causes this flat panel display D to display a video picture corresponding to the instruction signal. An example in which the smartphone uses all the communication function of exchanging information with the touch panel T, a function as the control means for the aforementioned flat panel display D, and a function as an arithmetic means or management means is illustrated in the aforementioned embodiment. Instead, a controller formed by a computer and the like may be separately provided in addition to the aforementioned smartphone, so that these functions are shared with this controller.

In the present embodiment, the touch panel T for manipulated input is provided outside the case 10. This touch panel T may be of various types including a resistive scheme, an electromagnetic induction scheme, a capacitive scheme, an infrared (optical waveguide) scheme and the like. The touch panel T preferably used herein includes a panel-shaped image display device such as a liquid crystal display panel, a plasma display panel and an organic EL display panel on the back of a control panel (transparent panel). From the viewpoint of operability, the touch panel T according to the present embodiment is preferably of the type which allows the input of information about coordinates in two directions orthogonal to each other (in this example, x and y directions) by using the entire surface (entire region) of a display screen Ta (LCD) thereof, as shown in FIG. 2. Also, it is desirable that the touch panel T is of the type which allows icons and the like as an alternative to buttons to appear at any position (region) on the display screen Ta. Of course, the aforementioned buttons and the like may be actual electromagnetic switches and the like disposed in a screen frame (bezel) portion of the touch panel T.

The connection between the aforementioned touch panel T and the smartphone also functioning as the aforementioned control means is either wireless connection using Bluetooth (registered trademark), wireless LAN and the like or wired connection using a cable and the like. The place where the aforementioned touch panel T is located need not particularly be a place near the display input device so long as it is within the range where the aforementioned wireless or wired connection can be established. The touch panel T may be located near an operator or at a favorite position in accordance with the type of usage thereof.

Other “input devices which allow an operator to manipulate with his or her finger” and which have no display screens, such as input devices in the form of a keyboard, a mouse and a tablet, for example, in addition to the aforementioned touch panel T may be used as the touch input device in the display input device according to the present invention. A display input part for another cellular mobile phone or a personal digital assistant may be used as the touch input device in the display input device according to the present invention (although the original functions are impaired). When this display input device can be used while being connected to a computer (personal computer) and the like as in an office, an input interface such as a keyboard, a mouse, a tablet and the like connected to the personal computer and the like may also function as the touch input device of the aforementioned display input device.

As shown in FIG. 1, the aforementioned transparent plate 2 is disposed in the opening of the upper surface of the case 10 which houses the aforementioned members. The inside surfaces of the case 10 have a black color (a chromaticity of 0; a saturation of 0; and a lightness of 0) or a dark color close to the black color for the purpose of preventing irregular reflection of light. As shown in FIGS. 2 and 3, an insertion opening 10a in the form of a slit through which the aforementioned flat panel display D (smartphone in the figure) is slid into the case 10 (onto the mounting stand 3) is provided in one side surface of the case 10.

Next, a method of projecting and displaying the real image (spatial image I′) for the image I over the aforementioned case 10 by using the aforementioned flat panel display D (smartphone) will be described.

For display (projection) of the aforementioned image I in the aforementioned display input device, a smartphone provided with the flat panel display D is initially prepared, and the image I (in FIGS. 2 and 3, a “photograph of a dog” as an example) subjected to predetermined processing (image processing such as change in background color and improvement in contrast) is displayed on this flat panel display D. Then, this smartphone is moved to near the side surface of the case 10 where the aforementioned insertion opening 10a is provided (with reference to the arrow A in FIGS. 2 and 3), with the aforementioned image I positioned upside down.

Next, with the aforementioned image I in the inverted position, the aforementioned smartphone is pushed through the aforementioned insertion opening 10a into the case 10 (the arrow B in FIGS. 2 and 3). Then, this smartphone slides horizontally on the mounting surface and is set at a predetermined position on the mounting stand 3 (position C in FIGS. 2 and 3). Thus, the planar two-dimensional image I (photograph and the like) displayed on the screen of the aforementioned flat panel display D is displayed (projected) as the spatial image I′ having a sense of depth (two-dimensional image appearing three-dimensional) over the panel-shaped image-forming optical element 1 (with reference to FIG. 2).

When another flat panel display different than that described above is disposed in an inclined attitude in place of the plate-like member 3a constituting the mounting surface of the aforementioned mounting stand 3, the display of the image I and the projection of the spatial image I′ are continued even if the aforementioned flat panel display D is not placed. It is preferable that the incorporation of a self light emitting display device such as an LED display and an LED digital clock in the mounting surface (plate-like member 3a) of the mounting stand 3 enables the display and projection to continue without interruption even in the case where the aforementioned flat panel display D is not placed (inserted). Further, when the aforementioned mounting stand 3 is configured to have a charging (charging stand or cradle) function for the aforementioned cellular mobile phone, the personal digital assistant and the like, it is possible to accomplish the charging for each device during the insertion inside the case 10. This achieves the effective use of the time for the charging.

In the display input device having the aforementioned configuration, the two-dimensional image I such as a photograph is projected (image-formed) as the spatial image I′ rich in realism and floating up three-dimensionally over the case 10 which houses the flat panel display D. Also, an operator uses his or her finger and the like to touch the display screen Ta of the aforementioned touch panel T, thereby carrying out the manipulated input which is not influenced by environments and conditions with reliability.

Next, a configuration example in which the aforementioned touch input device and a smartphone are integrated together will be described.

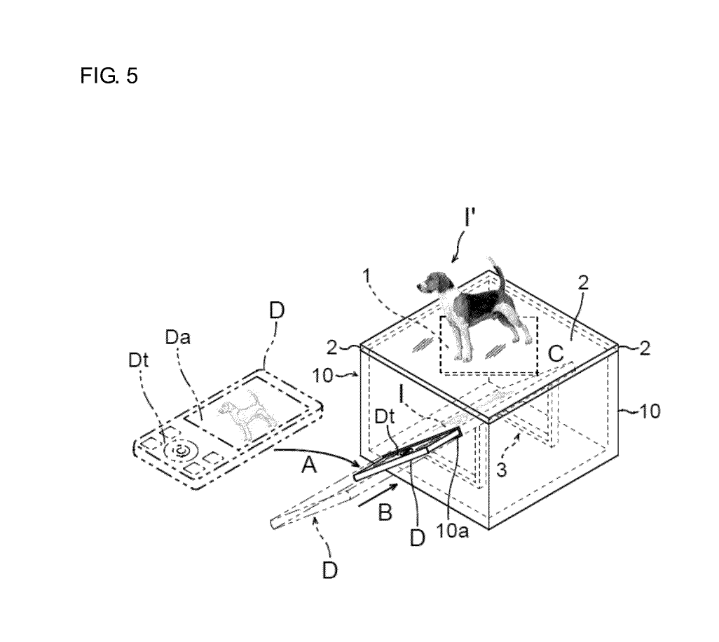

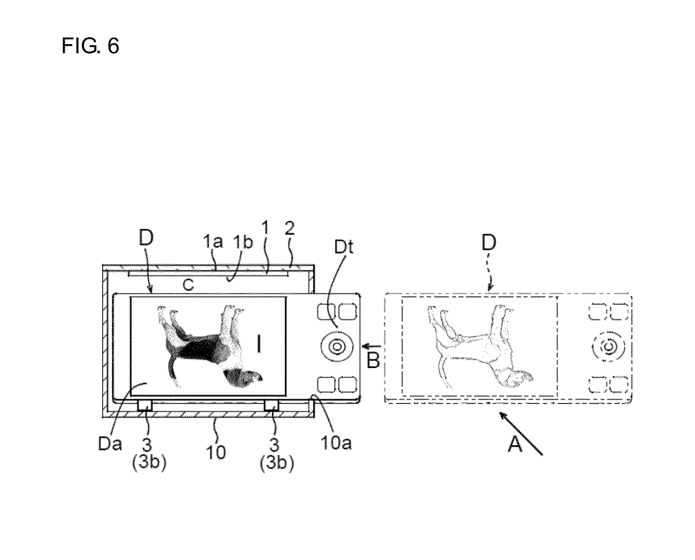

FIG. 5 is a schematic sectional view showing the configuration of the display input device according to a second embodiment of the present invention. FIG. 6 is a view illustrating a method of using the aforementioned display input device. Components similar to those of the first embodiment described above are designated by the same reference numerals and characters, and will not be described.

The display input device of the second embodiment shown in FIGS. 5 and 6 differs from that of the aforementioned first embodiment in that the touch input device for inputting (transmitting) operator's instructions to this display input device is not a separate body outside the case 10 but is configured as a portion (referred to hereinafter as a manipulation part Dt) of a manipulation part of the smartphone.

The manipulation part Dt of this smartphone is provided as a manipulated input part of a slider phone, a bar phone and the like. As shown in FIG. 6, when the image I (a photograph of a dog) is displayed on the display surface Da of the flat panel display D and this smartphone is pushed through the aforementioned insertion opening 10a into the case 10, the aforementioned manipulation part Dt protrudes from the insertion opening 10a outwardly of the case 10. This provides the operability and effects similar to those of the display input device of the aforementioned first embodiment without the need to prepare the touch panel T and the like as the aforementioned touch input device.

Next, a method of updating an image (video picture) displayed on the flat panel display D by using an instruction and positional information (coordinates) given by a finger and the like having touched the aforementioned touch input device (touch panel T) will be described.

For example, as shown in FIG. 2, when an upper coordinate input region (display region of x and y axes) and a lower icon touch region (rectangular icons such as M, N, T and B) appear on the display screen Ta of the touch panel T and an operator touches (inputs an instruction) the lower “M” mail icon (a specific region on the display screen Ta) with a finger and the like, the touch panel T detects the touch of the aforementioned finger and the like on the panel to send an instruction signal (code or event) corresponding to the icon to the control means (controller) of the aforementioned flat panel display D.

Upon receipt of the instruction signal corresponding to the aforementioned “M” mail icon, the controller checks for an E-mail, an SMS message and the like (new arrival) in a mailbox on a corresponding server through an arithmetic means (event processing engine) of the smartphone, a computer and the like and via communication lines to update (replace or render) the image appearing on the aforementioned flat panel display D to (with or into) an image corresponding to the result. Text (text information) corresponding to the result of the presence/absence of the aforementioned e-mail may be announced (read) with a voice from a loudspeaker built in the aforementioned smartphone or a voice output means and the like mounted to the outside at the same time that the aforementioned image is updated.

When a touch (instruction input) on the “N” news icon on the display screen Ta is detected, the image appearing on the flat panel display D is updated to an image corresponding to the update of news, weather forecasts, train running situations and the like on the Web, disaster information on earthquakes, Twitter (registered trademark), SNS and the like in a manner similar to that described above. Likewise, when a touch (instruction input) on the “T” time icon on the display screen Ta is detected, time data is acquired through the aforementioned arithmetic means and via the communication lines, and the image appearing on the flat panel display D is updated to an image corresponding to the current time. When a touch (instruction input) on the “B” batt. icon on the display screen Ta is detected, data about the remaining battery life of the aforementioned smartphone and the like is acquired through the aforementioned arithmetic means, a sensor and the like, and the image appearing on the aforementioned flat panel display D is updated to an image corresponding to the aforementioned remaining battery life. These updates of such types of information may be displayed using different displays (signs) depending on the types of information, and the updates may be announced with a voice.

Further, when an operator touches a different region than the icons on the aforementioned display screen Ta and uses his or her finger and the like to continuously input the path thereof (continuous pieces of coordinate information), the image I on the flat panel display D (i.e. the spatial image I′) may be continuously and interactively changed (updated) in accordance with the movement of the finger, based on the amount of change in the aforementioned finger coordinates. The different region than the icons may be used not only as a region in which operations are performed like a pointing device such as a mouse and a tablet but also as a region in which an instruction is inputted by drawing a specific figure with a single stroke (what is called “gesture input”) and as a region for character recognition (handwritten input).

A system which spontaneously acquires information on the Web such as mail and news by using the operator's input as a starting point (origin) [what is called “PULL distribution”] is taken as an example in the aforementioned embodiments. However, the display input device according to the present invention may also use a system which updates the image on the aforementioned flat panel display D in corresponding relation to automatic information distribution [what is called “PUSH distribution”] from the Web (network) to the cellular mobile phone and the like.

Further, an example in which the programs (engine) for use in the aforementioned control means, the arithmetic means and the like are operated locally in a smartphone and the like is illustrated. However, these programs may be dispersedly located in the aforementioned separately prepared controller and the like or located on the outside (server and the like) via a network such as a cloud network.

Although specific forms in the present invention have been described in the aforementioned embodiments, the aforementioned embodiments should be considered as merely illustrative and not restrictive. It is contemplated that various modifications evident to those skilled in the art could be made without departing from the scope of the present invention.

The display input device according to the present invention, which allows an operator to intuitively manipulate a spatial image projected in space in any type of environment, serves as a user interface device capable of interacting with the spatial image with ease.

### EXPLANATION OF REFERENCES

1 Image-forming optical element
1a Upper surface
1b Lower surface
2 Transparent plate
3 Mounting stand
3a Plate-like member
3b Bases
10 Case
11 Substrate
12 Unit optical elements
12a, 12b Side surfaces
12c Corners
D Flat panel display
Da Display surface
Dt Manipulation part
T Touch panel
Ta Display screen
P Element surface
I Image
I′ Spatial image

1. A display input device, the display input device comprising:
a flat panel display;
a mounting stand for placing the flat panel display thereon;
a control means for the flat panel display;
a panel-shaped image-forming optical element;
a case for housing the flat panel display, the mounting stand, the control means and the image-forming optical element; and
a touch input device disposed outside the case,
wherein the image-forming optical element is disposed at a predetermined position in an opening of an upper surface of the case,
wherein the mounting stand is disposed at a lower position of the case corresponding to the image-forming optical element in an attitude inclined at a predetermined angle with respect to the image-forming optical element,
wherein the touch input device is configured to convert an operator's instruction input into an instruction signal to transmit the instruction signal to the control means,
wherein the control means causes the flat panel display to display a video picture corresponding to the instruction signal, based on the instruction signal,
wherein the display input device image-forms a video picture displayed on a display surface of the flat panel display by means of the image-forming optical element in a manner floating up at a spatial position spaced apart from the image-forming optical element and for interactively updating the video picture on the flat panel display in response to the operator's instruction input.

2. The display input device according to claim 1, wherein said touch input device is a touch panel device allowing the input of coordinates in two directions orthogonal to each other.
